(19) United States
(12) Patent Application Publication
(10) Pub. No.: US 2013/0224609 A1
(43) Pub. Date: Aug. 29, 2013

(54) ELECTROLYTE AND LITHIUM AIR BATTERY INCLUDING THE SAME

(71) Applicants: SAMSUNG ELECTRONICS CO., LTD., (US); National University Corporation Mie University, (US)

(72) Inventors: Dong-joon LEE, Yongin-si (KR); Osamu YAMAMOTO, Tsu City (JP); Nobuyuki IMANISHI, Tsu City (JP); Dong-min IM, Yongin-si (KR)

(73) Assignees: NATIONAL UNIVERSITY CORPORATION MIE UNIVERSITY, Tsu City (KR); SAMSUNG ELECTRONICS CO., LTD., Suwon-si (KR)

(21) Appl. No.: 13/673,528

(22) Filed: Nov. 9, 2012

(30) Foreign Application Priority Data
Feb. 29, 2012 (KR) 10-2012-0021410

(51) Int. Cl. H01M 8/10

(52) U.S. Cl. CPC H01M 8/1018
USPC 429/403; 429/492

(57) ABSTRACT

An electrolyte including a lithium ion conductive polymer, a lithium salt, and an ionic liquid including an anion represented by Formula 1 below:

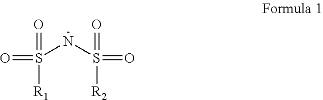

wherein, in Formula 1 above, R₁ and R₂ are defined herein.

### CROSS-REFERENCE TO RELATED APPLICATIONS

This application claims the benefit of Korean Patent Application No. 10-2012-0021410, filed on February 29, 2012, and all the benefits accruing therefrom under 35 U.S.C. §119, the content of which is incorporated herein in its entirety by reference.

### BACKGROUND

1. Field

The present disclosure relates to an electrolyte and a lithium air battery including the same.

2. Description of the Related Art

Lithium air batteries include a negative electrode which enables intercalation/deintercalation of lithium ions, a positive electrode including a catalyst for oxidation and reduction of oxygen in air which is used as a positive active material, and a lithium ion-conducting medium interposed between the positive electrode and the negative electrode.

Lithium air batteries have a theoretical energy density of 3,000 watt-hour per kilogram (Wh/kg) or greater, which is approximately 10 times greater than that of lithium ion batteries. In addition, lithium air batteries are environmentally friendly and more stable than lithium ion batteries, and thus, research into lithium ion batteries is being actively conducted.

Metallic lithium is used as a negative active material of a lithium air battery to ensure excellent capacity properties.

However, metallic lithium is unstable and highly reactive, and thus, it is sensitive to heat or impact, and has a high risk of explosion. When a negative electrode including lithium metal is used, lithium dendrites form or are deposited on a surface of the metallic lithium, and interfacial resistance between the negative electrode, and a membrane formed thereon is present. Thus, the characteristics of a lithium air battery using the negative electrode including lithium metal are not satisfactory, and thus, there is much need for improvement of the lithium air battery.

### SUMMARY

Provided are an electrolyte and a lithium air battery including the same.

An embodiment of this disclosure provides an electrolyte including, a lithium ion conductive polymer, a lithium salt, and an ionic liquid including an anion represented by Formula 1 below:

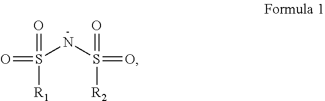

wherein, in Formula 1 above, R₁ and R₂ are the same and are fluorine, R₁ and R₂ are different and are fluorine or a perfluoroalkyl group, or R₁ and R₂ are connected to each other to form a ring, wherein all hydrogen atoms of the ring are substituted with fluorine or all hydrogen atoms of the ring are substituted with fluorine or a perfluoroalkyl group.

Another embodiment of this disclosure provides, a lithium air battery including a positive electrode; a first electrolyte; and a negative electrode, wherein the first electrolyte is disposed between the negative electrode and the positive electrode, and is the above-described electrolyte.

Embodiments of this disclosure will be further described in the following detailed description.

### BRIEF DESCRIPTION OF THE DRAWINGS

The above and other aspects, advantages and features of this disclosure will become apparent by describing in further detail the embodiments thereof, with reference to the accompanying drawings in which:

FIG. 1 is a schematic diagram of a lithium air battery according to embodiment as disclosed herein;

FIG. 2 is a schematic diagram of lithium air batteries according to another embodiment as disclosed herein;

FIG. 3 is a graph showing evaluation results of conductivity characteristics of cells 1 through 8 of Evaluation Example 1 and a comparative cell 1 wherein PEO₁₈LiTFSI-xPP13FSI denotes a composition of electrolyte of Examples 1-8 and X of PEO₁₈LiTFSI-xPP13FSI is an amount of PP13FSI;

FIGS. 4 through 6 are graphs showing measurement results of impedances of cells 7 through 9 and a comparative cell 1 wherein Li/PEO₁₈LiTFSI-1.44PP13FSI/Li in FIG. 4 denotes of the stack structure of Cell 7; and

FIG. 7 is a diagram showing a change in conductivity of each of the cells using the electrolytes of Examples 6 and 7 and Comparative Example 1 wherein PEO₁₈LiTFSI-xPP13FSI denotes a composition of electrolyte of Comparative Example 1, Cell 7 and Cell 8 and X of PEO₁₈LiTFSI-xPP13FSI is an amount of PP13FSI.

### DETAILED DESCRIPTION

This disclosure will be described more fully hereinafter with reference to the accompanying drawings, in which various embodiments are shown, wherein like reference numerals refer to the like elements throughout. This disclosure may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the thickness of layers, films, panels, regions, etc., are exaggerated for clarity.

It will be understood that when an element such as a layer, film, region, or substrate is referred to as being“disposed” on another element, it can be directly on the other element or intervening elements may also be present. In contrast, when an element is referred to as being “directly on” or “in contact with” another element, there are no intervening elements present.

The terminology used herein is for the purpose of describing particular embodiments only and is not intended to be limiting. As used here, the singular forms “a”, “an”, and “the” are intended to include the plural forms as well, including “at least one,” unless the content clearly indicates otherwise. “Or” means “and/or.” It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning consistent with their meaning in the context of the relevant art and the present disclosure, and will not be interpreted in an idealized or overly formal sense unless expressly so defined herein.

As used herein, when a definition is not otherwise provided, the prefix “hetero” refers to a compound or a group that includes at least one heteroatom wherein the heteroatom is each independently N, O, S, Si, or P. Throughout the present disclosure, reference is made to various heterocyclic groups. Within such groups, the term “hetero” means a compound or a group that includes at least one ring member (e.g., 1 to 4 ring members) that is a heteroatom (e.g., 1 to 4 heteroatoms, each independently N, O, S, Si, or P). The total number of ring members may be 3 to 10. If multiple rings are present, each ring is independently aromatic, saturated, or partially unsaturated, and multiple rings, if present, may be fused, pendant, spirocyclic, or a combination thereof. Heterocycloalkyl groups include at least one non-aromatic ring that contains a heteroatom ring member. Heteroaryl groups include at least one aromatic ring that contains a heteroatom ring member. Non-aromatic and/or carbocyclic rings may also be present in a heteroaryl group, provided that at least one ring is both aromatic and contains a ring member that is a heteroatom.

An “alkyl” group is a straight or branched saturated aliphatic hydrocarbon group having the specified number of carbon atoms and having a valence of at least one, optionally substituted with one or more substituents where indicated, provided that the valence of the alkyl group is not exceeded.

A “perfluoroalkyl” group is an alkyl group as defined above, wherein every hydrogen is replaced by a fluorine atom.

Hereinafter, exemplary embodiments of an electrolyte and a lithium air battery including the electrolyte will be described in more detail.

According to an embodiment of this disclosure, an electrolyte includes a lithium ion conductive polymer, a lithium salt, and an ionic liquid including an anion represented by Formula 1 below.

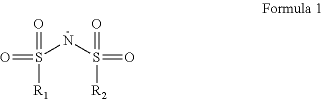

In Formula 1 above, R₁ and R₂ may be the same and may be fluorine, R₁ and R₂ may be different and may be fluorine or a perfluoroalkyl group, or R₁ and R₂ are connected to each other to form a ring, wherein all hydrogen atoms of the ring are substituted with fluorine or all hydrogen atoms of the ring are substituted with fluorine or a perfluoroalkyl group.

The perfluoroalkyl group may be —CF₃.

The ring may be a 5- to 10-membered ring, for example, 5- to 8-membered ring or a 5- to 6-membered ring. In the ring, all hydrogens may be substituted with fluorine, or some hydrogens of the ring may be substituted with fluorine and other hydrogens may be substituted with a perfluoroalkyl group.

In general, a solid electrolyte interface (“SEI”) including a degradation product of an electrolyte is disposed on a surface of a negative electrode of a battery.

However, a typical SEI formed of an electrolyte does not have membrane characteristics whereby lithium ions are selectively transmitted through a membrane. In particular, when a typical ionic liquid such as lithium bis(trifluoromethanesulfonyl)imide (“LiTFSI”) is used, other materials in addition to lithium ions are transmitted through the SEI, and reach a lithium negative electrode due to the hydrophobic properties of the SEI, and thus, the lithium ion conductivity of the lithium negative electrode is low. In addition, since lithium dendrites form and grow at an interface between the negative electrode and a membrane formed adjacent thereto, interfacial resistance between the negative electrode and a membrane formed adjacent thereto is increased. As a result, a battery using the electrolyte including the typical ionic liquid may have low conductivity, stability, and lifetime. Accordingly, while not wishing to be bound by theory, it is believed the electrolyte of this disclosure according to an embodiment, reduces or prevents lithium dendrite from forming or growing at an interface between a negative electrode and a membrane formed adjacent thereto, while having membrane properties whereby only lithium ions are selectively transmitted through a SEI formed on a surface of the negative electrode, thereby reducing interfacial resistance between the negative electrode and the membrane formed adjacent thereto, and efficiently reducing or preventing lithium dendrites from forming on the surface of the negative electrode, and/or from such dendrites growing.

The SEI may have membrane properties whereby only lithium ions are selectively transmitted through the SEI by appropriately controlling hydrophobic properties of the SEI, by using an electrolyte including an ionic liquid including the anion represented by Formula 1 above.

In addition, since R₁ and R₂ of Formula 1 may be both fluorine or may be fluorine or a perfluoroalkyl group, the SEI may be formed by using the ionic liquid to have hydrophobic properties, whereby lithium ions are easily transmitted through a surface of a negative electrode. Thus, while not wishing to be bound by theory, it is believed interfacial resistance between a negative electrode and the SEI and/or between the negative electrode and a membrane formed thereon may be reduced, and thus, conductivity of a battery using the electrolyte including the ionic liquid may be improved, and an excellent charge/discharge efficiency of a battery using the electrolyte including the ionic liquid may be obtained.

The ionic liquid may further include, for example, a cation selected from an ammonium cation, an imidazolium cation, a pyrrolidinium cation, a piperidinium cation, a phosphonium cation, and a combination thereof.

The ammonium cation may be a linear or branched C₁-C₁₀ alkyl substituted ammonium cation.

The anion represented by Formula 1 above may be an anion selected from an anion represented by Formulae 2 through 4 below, and a combination thereof.

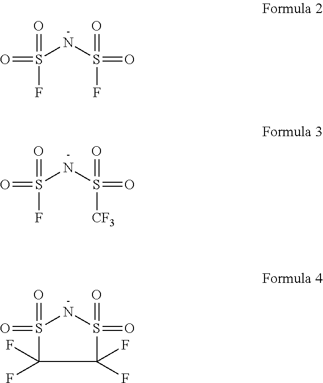 [SMILES: O=S(=O)(F)NS(=O)(=O)F ; O=S(=O)(F)NS(=O)(=O)C(F)(F)F ; O=S1(=O)NS(=O)(=O)C(F)(F)C1(F)F]

The ionic liquid may include a cation selected from a cation represented by Formulae 5 through 7 below, and a combination thereof.

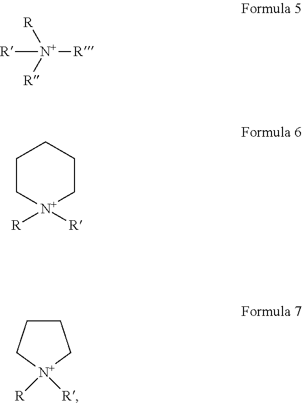

wherein, in Formulae 5 through 7, R, R′, R″, and R′″ are each independently a C₁-C₁₀ alkyl group.

The ionic liquid may include a cation selected from a cation represented by Formulae 5A through 8A below, and a combination thereof.

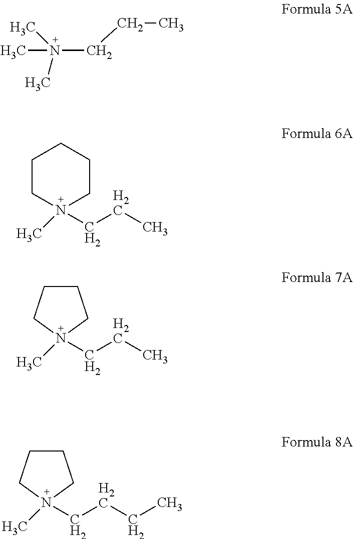

The ionic liquid may be a salt selected from a salt represented by Formulae 8 through 13 below, and a combination thereof.

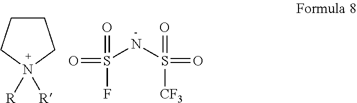

In Formula 9 above, R and R′ are each independently a C₁-C₁₀ alkyl group.

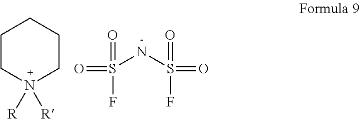

In Formula 10 above, R and R′ are each independently a C₁-C₁₀ alkyl group.

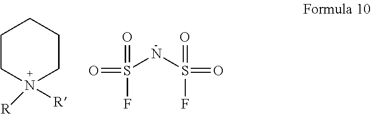

In Formula 11 above, R and R′ are each independently a C₁-C₁₀ alkyl group.

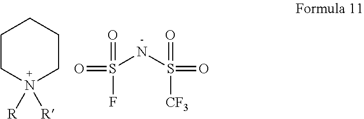

In Formula 12 above, R and R′ are each independently a C₁-C₁₀ alkyl group.

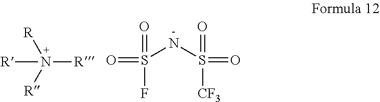

In Formula 13 above, R, R′, R″, and R′″ are each independently a C₁-C₁₀ alkyl group.

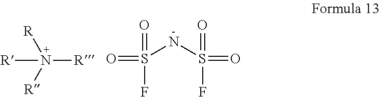

In Formula 14 above, R, R′, R″, and R′″ are each independently a C₁-C₁₀ alkyl group.

The ionic liquid, for example, may be a salt selected from a salt represented by Formulae 14 through 19 below, and a combination thereof.

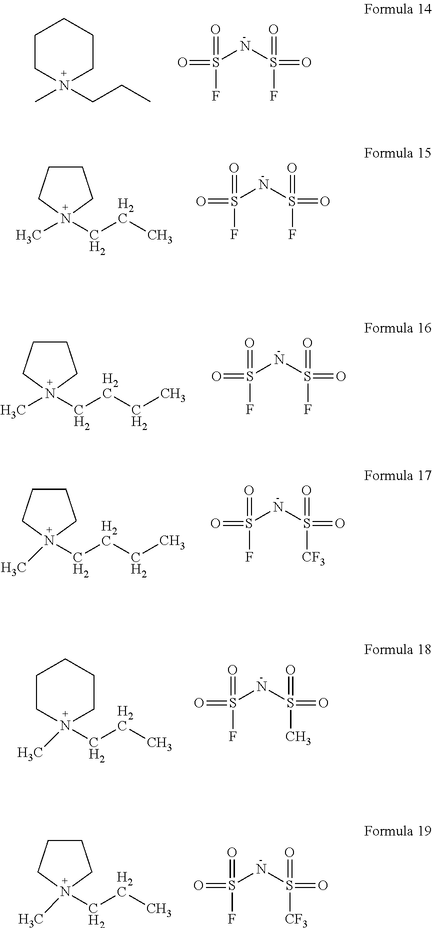

The amount of the ionic liquid in the electrolyte may be in the range of about 0.1 moles (mol) to about 2 moles, based on 1 mole of the lithium ion conductive polymer. When the amount of the ionic liquid falls within this range, lithium dendrite may be prevented or reduced from being formed on a surface of a negative electrode and interfacial resistance between the negative electrode and a membrane adjacent thereto may be reduced.

The lithium salt may be dissolved in a solvent and may function as a source of lithium ions. For example, the lithium salt may facilitate migration of lithium ions between the negative electrode and a lithium ion conductive solid electrolyte membrane, i.e., a protective layer that may be included in the lithium air battery as further described below.

The lithium salt may be a compound selected from LiPF₆, LiBF₄, LiSbF₆, LiAsF₆, LiN(SO₂C₂F₅)₂, LiN(SO₂F₂)₂, Li(CF₃SO₂)₂N (e.g., lithium bis(trifluoromethanesulfonyl)imide (“LiTFSI”)), LiC₄F₉SO₃, LiClO₄, LiAlO₂, LiAlCl₄, LiN(CₓF₂ₓ₊₁SO₂)(C_{y}F_{2y+1}SO₂) wherein, x and y are integers ranging from 0 to 10, LiF, LiBr, LiCl, LiI, LiB(C₂O₄)₂ (i.e., lithium bis(oxalato)borate (“LiBOB”)), and a combination thereof.

The amount of the lithium salt is present in the electrolyte to provide a ratio of moles of lithium ions/moles of oxygen atoms of the lithium ion conductive polymer, of about 1/6 to about 1/54. When the amount of the lithium salt satisfies this range, an electrolyte has appropriate conductivity and viscosity and thus may exhibit excellent or improved electrolyte performance, and allow lithium ions to effectively migrate.

Any lithium ion conductive polymer may be used as the lithium ion conductive polymer. Non-limiting examples of the lithium ion conductive polymer may include a polyethylene oxide, a polypropyleneoxide, a polyacrylonitrile, a polyvinylidene fluoride, a polyurethane, a polyacrylate, a polymethacrylate, or a cellulose-based resin. Use of a polyethylene oxide as the lithium ion conductive polymer is specifically mentioned.

The lithium ion conductive polymer may have a weight-average molecular weight in the range of about 100,000 grams per mole (g/mol) to about 1,000,000 g/mol, specifically about 200,000 g/mol to about 900,000 g/mol, more specifically about 300,000 g/mol to about 800,000 g/mol. Use of a lithium ion conductive polymer with a weight-average molecular weight of about 600,000 g/mol, is specifically mentioned. When the lithium ion conductive polymer having the weight-average molecular weight in this range is used, the electrolyte has excellent or improved physical properties and conductivity.

The ionic liquid may further include an inorganic filler. While not wishing to be bound by theory, it is believed when the inorganic filler is included in the ionic liquid, the durability of a battery may be further increased when the ionic liquid is combined with a lithium negative electrode of the battery.

The inorganic filler may be any inorganic filler as long as the inorganic filler is compatible with a lithium air battery.

For example, the inorganic filler may include an inorganic compound selected from BaTiO₃, SiO₂, TiO₂, ZrO₂, zeolite, and a combination thereof.

The amount of the inorganic filler in the electrolyte may be in the range of about 0.1 to about 20 parts by weight, specifically about 1 to about 18 parts by weight, more specifically about 8 to about 15 parts by weight, based on 100 parts by weight of a total weight of the lithium ion conductive polymer, the lithium salt, and the ionic liquid.

The electrolyte may further include a non-aqueous solvent selected from a carbonate-containing solvent, an ester-containing solvent, an ether-containing solvent, a ketone-containing solvent, an amine-containing solvent, a phosphine-containing solvent, and a combination thereof.

Non-limiting examples of the carbonate-containing solvent include dimethyl carbonate (“DMC”), diethyl carbonate (“DEC”), ethylmethyl carbonate (“EMC”), dipropyl carbonate (“DPC”), methyl propyl carbonate (“MPC”), ethylpropyl carbonate (“EPC”), methylethyl carbonate (“MEC”), ethylene carbonate (“EC”), propylene carbonate (“PC”), and butylene carbonate (“BC”).

Non-limiting examples of the ester-containing solvent include methyl acetate, ethyl acetate, n-propyl acetate, dimethyl acetate, methyl propionate, ethyl propionate, γ-butyrolactone, decanolide, valerolactone, mevalonolactone, and caprolactone.

Non-limiting examples of the ether-containing solvent include dibutyl ether, tetraglyme, diglyme, dimethoxyethane, 2-methyltetrahydrofuran, and tetrahydrofuran. Non-limiting examples of the ketone-containing solvent include cyclohexanone.

Non-limiting examples of the amine-containing solvent include triethylamine and triphenylamine. A non-limiting example of the phosphine-containing solvent includes triethylphosphine. However, the non-aqueous solvent is not limited to the above-described examples, and any aprotic solvent may be used.

Non-limiting examples of the aprotic solvent include nitriles, such as R—CN (wherein R is a C₂-C₂₀ linear, branched, or cyclic hydrocarbon group, and may include a double-bonded aromatic ring or an ether bond), amides, such as N,N-dimethylformamide, dioxolanes, such as 1,3-dioxolane, and sulfolane.

The aprotic solvent may be used alone or in combination with the non-aqueous solvent. When the aprotic solvent is used in combination with the non-aqueous solvent, a mixing ratio may be appropriately adjusted according to cell performances.

The electrolyte may be, for example, an electrolyte for a lithium air battery.

According to another embodiment of the present invention, a lithium air battery includes the above-described electrolyte.

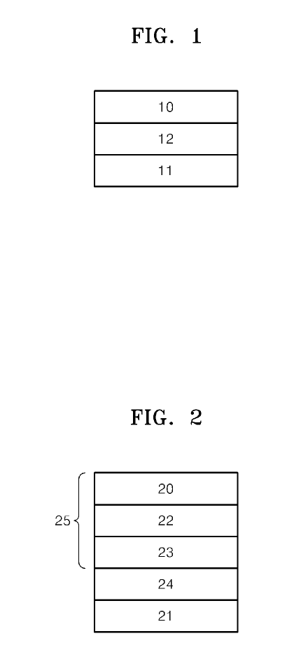

An example of a lithium air battery according to an embodiment of this disclosure is shown in FIG. 1.

Referring to FIG. 1, a first electrolyte 12 is interposed (i.e., disposed) between a negative electrode 10 and a positive electrode 11.

The first electrolyte 12 according to an embodiment of this disclosure, includes the lithium ion conductive polymer, the lithium salt, and the ionic liquid including the anion represented by Formula 1 above. In an embodiment, the perfluoroalkyl group recited in the description of R₁ and R₂ of Formula 1 above, is —CF₃.

The electrolyte 12 may be in a gel state or a semi-solid state.

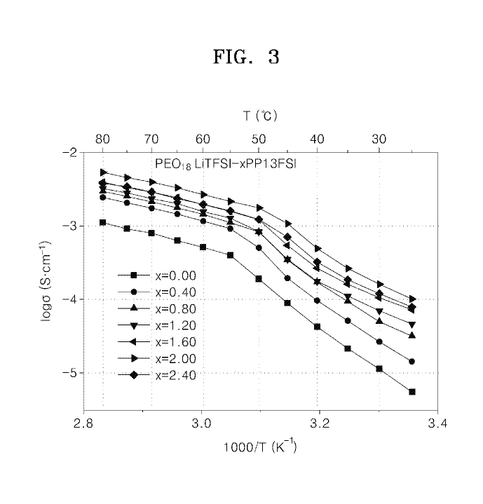

FIG. 2 is a schematic diagram of a lithium air battery according to another embodiment of this disclosure.

Referring to FIG. 2, a first electrolyte 22 including the lithium ion conductive polymer, the lithium salt, and the ionic liquid including the anion represented by Formula 1 above, is disposed between a negative electrode 20 and a positive electrode 21. In addition, a protective layer 23 is interposed (i.e., disposed) between the first electrolyte 22, and the positive electrode 21. A second electrolyte 24 is interposed (i.e., disposed) between the positive electrode 21 and the protective layer 23.

In FIG. 2, the negative electrode 20, the first electrolyte 22, and the protective layer 23 constitute a protective negative electrode 25.

According to an embodiment of this disclosure, a resistance per unit area of the protective negative electrode 25 may be reduced while the ion conductivity between the negative electrode 20 and the first electrolyte 22 is increased.

A thickness ratio of the negative electrode 20 and the protective layer 23 may range from about 0.001 micrometers (μm) to about 1000 μm, specifically, about 0.01 μm to about 500 μm, more specifically, about 0.01 μm to about 100 μm.

The negative electrode 20 may have a thickness ranging from about 10 to about 300 μm, specifically about 15 to about 250 μm, more specifically about 20 to about 200 μm. The protective layer 23 may have a thickness ranging from about 10 to about 500 μm, specifically about 20 to about 450 μm, more specifically about 30 to about 350 μm. A total thickness of the protective negative electrode 25 may range from about 20 to about 800 μm, specifically about 25 to about 750 μm, more specifically about 50 to about 600 μm.

Each of the positive electrodes 11 and 21 of FIGS. 1 and 2 respectively, may be disposed or formed on a first current collector (not shown), and may use oxygen as a positive active material. In addition, each of the negative electrodes 10 and 20 of FIGS. 1 and 2 respectively, may be disposed or formed on a second current collector (not shown), and may enable intercalation/deintercalation of lithium ions.

The thicknesses of components according to an embodiment, are not limited to the thicknesses of components shown in FIGS. 1 and 2.

The second electrolyte 24 of FIG. 2 may be partially or entirely impregnated in the positive electrode 21.

The protective layer 23 may include a membrane selected from an inorganic solid electrolyte membrane, a polymer solid electrolyte membrane, a gel-type polymer electrolyte membrane, a lithium ion conductive solid electrolyte membrane, and a combination thereof.

The second electrolyte 24 may include a material selected from a liquid electrolyte including a separator, a non-aqueous solvent, and a lithium salt, an inorganic solid electrolyte membrane, a polymer solid electrolyte membrane, a gel-type polymer electrolyte membrane, a lithium ion conductive solid electrolyte membrane, and a combination thereof.

The inorganic solid electrolyte membrane, the polymer solid electrolyte membrane, the gel-type polymer electrolyte, and the lithium ion conductive solid electrolyte membrane may be the same or different in the protective layer and the second electrolyte.

In an embodiment, the liquid electrolyte includes a non-aqueous solvent and a lithium salt, and may include a separator. In an embodiment, the non-aqueous solvent of the liquid electrolyte may the same as the non-aqueous solvent described above for the ionic liquid.

The amount of the lithium salt in the liquid electrolyte may range from about 0.01 to about 10 Molar (M), specifically about 0.05 to about 8 M, more specifically about 0.1 to about 2.0 M. When the amount of the lithium salt in the liquid electrolyte is within this range, the second electrolyte has appropriate conductivity and viscosity and thus may exhibit excellent or improved electrolyte performance and allow lithium ions to effectively migrate.

The liquid electrolyte may further include other metal salts, in addition to the lithium salt. Non-limiting examples of the metal salts include AlCl₃, MgCl₂, NaCl, KCl, NaBr, KBr, and CaCl₂.

The separator is not particularly limited as long as it has high endurance during lithium air battery operations. For example, the separator may be a porous film, a material selected from polypropylene or polyethylene, a polymer non-fabric, such as a polypropylene non-fabric or a polyphenylene sulfide non-fabric, and a combination thereof. The separator material may include a combination of at least two of these materials.

The inorganic solid electrolyte membrane may include a nitride selected from Cu₃N, Li₃N, lithium phosphorus oxynitride (LiPON), and a combination thereof.

The polymer solid electrolyte membrane may be a polyethylene oxide membrane.

The polymer solid electrolyte membrane may be prepared by mixing a lithium ion conductive polymer and a lithium salt.

The amount of the lithium salt in the polymer solid electrolyte membrane may range from about 0.01 to about 10 M, specifically about 0.05 to about 8 M, more specifically about 0.1 to about 2.0 M. When the amount of the lithium salt in the polymer solid electrolyte membrane is within this range, the second electrolyte has appropriate conductivity and viscosity and thus may exhibit excellent or improved electrolyte performance and allow lithium ions to effectively migrate.

The lithium salt may include a compound selected from LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) wherein, x and y are integers ranging from 0 to 10, LiF, LiBr, LiCl, LiI, LiB(C₂O₄)₂ (i.e., lithium bis(oxalato)borate (“LiBOB”)), and a combination thereof.

Non-limiting examples of the lithium ion conductive polymer in the polymer solid electrolyte membrane include a polyethylene oxide, a polyacrylonitrile, and a polyester.

The lithium ion conductive solid electrolyte membrane may include an inorganic material, a polymer solid electrolyte component, and a combination thereof.

The gel-type polymer electrolyte may include a polymer selected from a polyethylene oxide, a polyacrylonitrile, a polymethyl methacrylate, a polyvinylidene fluoride, a poly(acrylonitrile), a poly(methylmethacrylate), and a combination thereof.

The lithium ion conductive solid electrolyte membrane may be a solid electrolyte selected from a glass-ceramic solid electrolyte, a laminated structure of a glass-ceramic solid electrolyte, a polymer solid electrolyte, and a combination thereof.

The lithium ion conductive solid electrolyte membrane will now be described in more detail.

A material for forming the lithium ion conductive solid electrolyte membrane may be selected from a lithium ion conductive glass, a lithium ion conductive crystal, wherein the crystal may be a ceramic crystal or a glass-ceramic crystal, and a combination thereof. The material for forming the lithium ion conductive solid electrolyte membrane may further include an oxide, to facilitate chemical stability of the lithium ion conductive solid electrolyte membrane.

While not wishing to be bound by theory, it is believed when the lithium ion conductive solid electrolyte membrane includes a large amount of lithium ion conductive crystals, such as 50 percent by weight or greater, based on the total weight of the lithium ion conductive solid electrolyte membrane, the lithium ion conductive solid electrolyte membrane has high ionic conductivity. Accordingly, in an embodiment, the amount of the lithium ion conductive crystals may be 50 percent by weight (wt %) or greater, specifically 55 wt % or greater, more specifically 60 wt % or greater, based on the total weight of the lithium ion conductive solid electrolyte membrane.

Non-limiting examples of the lithium ion conductive crystal include a perovskite crystal with lithium ion conductivity, such as Li₃N, lithium super ionic conductor electrolyte (“LiSICON”), and La_{0.55}Li_{0.35}TiO₃, a LiTi₂P₃O₁₂ crystal having a sodium super ionic conductor electrolyte (“NaSICON”) structure, and a lithium ion conductive glass-ceramic.

For example, the lithium ion conductive crystal may be Li_{1+x+y}(Al, Ga)ₓ(Ti, Ge)₂₋ₓSi_{y}P_{3-y}O₁₂ wherein O≦x≦1, O≦y≦1, for example, 0≦x≦0.4 and 0≦y≦0.6, or 0.1≦x≦0.3 and 0.1≦y≦0.4.

Non-limiting examples of the lithium ion conductive glass-ceramic crystal material (e.g., glass-ceramic) include a lithium-aluminum-germanium-phosphate (“LAGP”), a lithium-aluminum-titanium-phosphate (“LATP”), and a lithium-aluminum-titanium-silicon-phosphate (“LATSP”).

For example, when a parent glass having a composition of Li₂O—Al₂O₃—TiO₂—SiO₂—P₂O₅ is crystallized by heat treatment, a main crystal phase of the parent glass includes Li_{1+x+y}AlₓTi₂₋ₓSi_{y}P_{3-y}O₁₂, wherein 0≦x≦1 and 0≦y≦1. In an embodiment, x and y may satisfy the conditions: 0≦x≦0.4 and 0≦y≦0.6. In another embodiment, x and y may satisfy the conditions: 0.1≦x≦0.3 and 0.1≦y≦0.4.

The glass-ceramic may be prepared by heat treating glass to deposit a crystalline phase in a glass phase. The glass-ceramic may include a material selected from an amorphous solid and crystals, a material in which all glass phases are phase-transitioned to crystalline phases, for example, a material in which the amount of crystals is 100 percent by weight, and a combination thereof. In the material in which the amount of crystals is 100 percent by weight, almost no pores exist between crystal particles or within the crystals.

The lithium ion conductive solid electrolyte membrane may include a large amount of the glass-ceramic, such as 80 wt % or greater, based on the total weight of the lithium ion conductive solid electrolyte membrane, and thus the lithium ion conductive solid electrolyte membrane may have high ionic conductivity. Therefore, 80 wt % or greater of the lithium ion conductive glass-ceramic crystal material may be included in the lithium ion conductive solid electrolyte membrane, based on the total weight of the lithium ion conductive solid electrolyte membrane. To obtain higher ionic conductivity, the amount of the lithium ion conductive glass ceramic material in the lithium ion conductive solid electrolyte membrane may be 85 wt % or greater, or 90 wt % or greater.

The material for forming the lithium ion conductive solid electrolyte membrane may further include an oxide selected from Li₂O, Al₂O₃, TiO₂, SiO₂, P₂O₅, Ga₂O₃, GeO₂, and a combination thereof.

Lithium oxide (Li₂O) may be included in the glass-ceramic, and provides a Li⁺ ion carrier to facilitate lithium ion conductivity.

The amount of the Li₂O may be about 12 mole percent (mol %) to about 18 mol %, for example, 12 mol %, 13 mol %, 14 mol %, 16 mol %, 17 mol %, or 18 mol %, based on a total moles of the glass-ceramic. When the amount of the Li₂O is within this range, the oxide may facilitate the formation of the glass-ceramic with excellent or improved thermal stability and conductivity.

Aluminum oxide (Al₂O₃) may be included in the glass-ceramic, and increases a thermal stability of a parent glass and also effectively increases lithium ion conductivity such that Al³⁺ ions are introduced into the crystalline phase.

The amount of the Al₂O₃ may be about 5 mol % to about 10 mol %, for example, 5 mol %, 5.5 mol %, 6 mol %, 9 mol %, 9.5 mol %, or 10 mol %, based on a total moles of the glass-ceramic. When the amount of the Al₂O₃ is within this range, the glass-ceramic may have excellent or improved conductivity without decreasing thermal stability.

Titanium oxide (TiO₂) may be included in the glass-ceramic, and contributes to the formation of glass, is a constituent of the crystalline phase, and is an essential component in glass and the crystals. The amount of the TiO₂ may be about 35 mol % to about 45 mol %, for example, 35 mol %, 36 mol %, 37 mol %, 42 mol %, 43 mol % or 45 mol %, based on a total moles of the glass-ceramic.

When the amount of the TiO₂ is within this range, the glass-ceramic may have high thermal stability and ion conductivity.

Silicon oxide (SiO₂) may be included in the glass-ceramic and may increase the melting properties and thermal stability of a parent glass and also contributes to improvement of lithium ion conductivity such that Si⁴⁺ ions are introduced into the crystalline phase.

The amount of the SiO₂ may be about 1 mol % to about 10 mol %, for example, 1 mol %, 2 mol %, 3 mol %, 7 mol %, 8 mol %, or 10 mol %, based on a total moles of the glass-ceramic. When the amount of the SiO₂ is within this range, the glass-ceramic may have good conductivity.

Phosphorus oxide (P₂O₅) may be included in the glass-ceramic, and is useful in forming glass, and a constituent of the crystalline phase.

The amount of the P₂O₅ may be about 30 mol % to about 40 mol %, for example, 30 mol %, 32 mol %, 33 mol %, 38 mol %, 39 mol % or 40 mol %, based on a total moles of the glass-ceramic. When the amount of the P₂O₅ is within this range, it may facilitate the glassifying of the glass-ceramic and to form the precipitation of the crystalline phase from the glass-ceramic.

In an embodiment, when the parent glass includes an oxide described above, glass may be more easily obtained by casting melted glass, and the glass-ceramic which is obtained by heat treating the glass, may have high lithium ion conductivity, for example, 1×10⁻² siemens per centimeter (S·cm⁻¹), to 1×10⁻⁴. A lithium ion conductivity of 1×10⁻³ S·cm⁻¹, is specifically mentioned.

The glass-ceramic may include an oxide selected from Li₂O, Al₂O₃, TiO₂, SiO₂, P₂O₅, Ga₂O₃, GeO₂, and a combination thereof, as described above. In an embodiment one or more oxides may be substituted with an oxide selected from Ga₂O₃, GeO₂, and a combination thereof. For example, the Al₂O₃ may be substituted with the Ga₂O₃, and the TiO₂ may be substituted with the GeO₂. The glass-ceramic may further include a raw material in an amount which does not deteriorate ionic conductivity, in order to reduce a melting point of the glass-ceramic or increase the stability of glass.

The lithium ion conductive solid electrolyte membrane may further include a polymer solid electrolyte component, in addition to the glass-ceramic component. The polymer solid electrolyte is a lithium salt-doped polyalkylene oxide. Non-limiting examples of the polyalkylene oxide include polyethylene oxide, polypropylene oxide, polybutylene oxide, and the like. Non-limiting examples of the lithium salt include LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, and LiAlCl₄.

The lithium ion conductive solid electrolyte membrane may have a laminated structure including the glass-ceramic solid electrolyte. For example, the glass-ceramic solid electrolyte may be interposed between a first lithium ion conductive solid electrolyte membrane and a second lithium ion conductive solid electrolyte membrane.

The lithium ion conductive solid electrolyte membrane may be a single layer or a multilayer form.

The positive electrode of the lithium air battery (e.g., cathode) that uses oxygen as a positive active material (e.g., cathode active material) according to an embodiment, may further include a cathode active material selected from a conductive material, a carbonaceous material, a metallic conductive material, a metallic powder, an organic conductive material, and a combination thereof. The conductive material may also be a porous material. Thus, any cathode active material having effective porosity and conductivity may be used. For example, a carbonaceous material with porosity may be used. Non-limiting examples of the carbonaceous material include a carbon blacks, graphites, graphenes, activated carbons, and carbon fibers. Non-limiting examples of the metallic conductive material include a metal fiber, and a metal mesh. Also, the cathode active material includes a metallic powder including copper, silver, nickel, or aluminum. Non-limiting examples of the organic conductive material include a polyarylene, for example a polyphenylene derivative. The conductive materials may be used alone or in combination.

A catalyst for oxidation/reduction of oxygen may be added to the cathode. Examples of the catalyst include, but are not limited to, a precious metal-containing catalyst such as platinum, gold, silver, palladium, ruthenium, rhodium, and osmium; an oxide-containing catalyst such as a manganese oxide, an iron oxide, a cobalt oxide, and a nickel oxide; and an organic metal-containing catalyst such as cobalt phthalocyanine. Any known catalyst for oxidation/reduction of oxygen may be used.

In addition, the catalyst may be supported on a catalyst support. The catalyst support may be a support selected from oxide, zeolite, clay-based mineral, carbon, and a combination thereof. The oxide may be an oxide selected from aluminum oxide, silicon oxide, zirconium oxide, titanium dioxide, and a combination thereof. The oxide may be an oxide including a metal wherein the metal is selected from cerium (Ce), praseodymium (Pr), samarium (Sm), europium (Eu), terbium (Tb), thulium (Tm), ytterbium (Yb), antimony (Sb), bismuth (Bi), vanadium (V), chromium (Cr), manganese (Mn), iron (Fe), cobalt (Co), nickel (Ni), copper (Cu), niobium (Nb), molybdenum (Mo), tungsten (W), and a combination thereof. Non-limiting examples of the carbon support include a carbon black such as Ketjen black, an acetylene black, a channel black, and a lamp black; a graphite such as a natural graphite, an artificial black, and an expandable graphite; an activated carbon; and a carbon fiber. However, the catalyst support is not limited to the above examples, and any known catalyst support may be used.

The cathode may further include a binder selected from a thermo-plastic resin, a thermosetting resin, and a combination thereof. Non-limiting examples of the binder include polyethylene, polypropylene, polytetrafluoroethylene (PTFE), polyvinylidene fluoride (PVDF), styrene-butadiene rubber, a tetrafluoroethylene-perfluoroalkylvinylether copolymer, a vinylidene fluoride-hexafluoropropylene copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethylvinylether-tetrafluoroethylene copolymer, and an ethylene-acrylic acid copolymer. In this regard, the binder may be used alone or in combination. However, the binder is not limited to the above examples, and any binder used in the art may be used.

The cathode may be prepared by combining (e.g., mixing) the catalyst for oxidation/reduction of oxygen, the conductive material, the binder, and an appropriate solvent thereto to provide a cathode slurry, coating the cathode slurry on a surface of a current collector, to provide a coated current collector, and drying the resultant coated current collector, to provide the cathode. Alternatively, the cathode may be prepared by compression-molding the cathode slurry to a surface of the current collector in order to increase the density of the cathode. In addition, the cathode may further include an oxide, for example a lithium oxide. The combining may be performed in any order, for example, the catalyst, and the conductive material may first be combined and the binder may be added thereto, or the binder may be combined with the catalyst prior to addition of the conductive material.

To rapidly diffuse oxygen, the current collector may be selected from a porous structure having a net or mesh form, a porous metal plate formed of stainless steel, nickel, or aluminum, and a combination thereof. However, the current collector is not limited to the above examples, and any known current collector may be used. The current collector may be coated with an oxidation resistant metal or alloy in order to prevent or reduce the current collector from being oxidized.

The lithium air battery according to an embodiment of this disclosure, has improved conductivity and thus has improved cell performances, such as charge and discharge characteristics, lifetime, and electrical performance.

The term “air” used herein is not limited to atmospheric air, and refers to either a gas combination including oxygen or a pure oxygen gas. The broad definition of the term “air” may be applied to various applications including an air battery, and an air cathode.

The lithium air battery may be a lithium primary battery or a lithium secondary battery. Also, the shape of the lithium air battery is not limited. Non-limiting examples of the shape of the lithium air battery include a coin-shape, a button-shape, a sheet-shape, a stack-shape, a cylinder-shape, a panel-shape, and a corn-shape. Also, the lithium air battery may be used in a large-size battery for electrical vehicles, although the lithium air battery is not limited to such use.

Hereinafter, the embodiments of this disclosure will be described in more detail with reference to the following examples. However, these examples are exemplary embodiments and are not limiting of the claims.

### EXAMPLE 1

### Preparation of Electrolyte

An electrolyte was prepared by mixing 1 mol of polyethylene oxide (H—[O—CH₂CH₂]₁₈—OH) (polymerization degree: 18, weight-average molecular weight: about 600,000 g/mol, (“PEO₁₈”)), 1 mol of LiTFSI(LiN(SO₂CF₃)₂), and 0.4 mol of a compound represented by Formula 15 below.

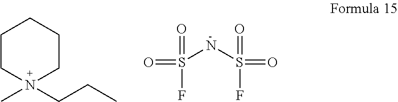

### EXAMPLE 2

### Preparation of Electrolyte

An electrolyte was prepared in the same manner as in Example 1, except that the amount of the compound represented by Formula 15 above was 0.80 mol.

### EXAMPLE 3

### Preparation of Electrolyte

An electrolyte was prepared in the same manner as in Example 1, except that the amount of the compound represented by Formula 15 above was 1.20 mol.

### EXAMPLE 4

### Preparation of Electrolyte

An electrolyte was prepared in the same manner as in Example 1, except that the amount of the compound represented by Formula 15 above was 1.60 mol.

### EXAMPLE 5

### Preparation of Electrolyte

An electrolyte was prepared in the same manner as in Example 1, except that the amount of the compound represented by Formula 15 above was 2.00 mol.

### EXAMPLE 6

### Preparation of Electrolyte

An electrolyte was prepared in the same manner as in Example 1, except that the amount of the compound represented by Formula 15 above was 1.44 mol.

### EXAMPLE 7

### Preparation of Electrolyte

An electrolyte was prepared in the same manner as in Example 1, except that the amount of the compound represented by Formula 15 above was 1.44 mol and 10 parts by weight of BaTiO₃ was further added to 100 parts by weight of a total weight of polyethylene oxide, LiTFSI(LiN(SO₂CF₃)₂), and the compound represented by Formula 15 above.

### EXAMPLE 8

### Preparation of Electrolyte

An electrolyte was prepared in the same manner as in Example 1, except that the amount of the compound represented by Formula 15 above was 2.40 mol.

### COMPARATIVE EXAMPLE 1

### Preparation of Electrolyte

An electrolyte was prepared in the same manner as in Example 1, except that the compound represented by Formula 15 above was not added.

### COMPARATIVE EXAMPLE 2

### Preparation of Electrolyte

An electrolyte was prepared in the same manner as in Example 1, except that 0.48 mol of a compound of Formula 21 below was used instead of 0.4 mol of the compound represented by Formula 15 above.

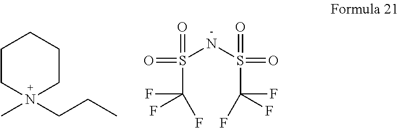

### COMPARATIVE EXAMPLE 3

### Preparation of Electrolyte

An electrolyte was prepared in the same manner as in Comparative Example 2, except that 0.96 mol of the compound represented by Formula 21 above was used.

### COMPARATIVE EXAMPLE 4

### Preparation of Electrolyte

An electrolyte was prepared in the same manner as in Comparative Example 2, except that 1.44 mol of the compound represented by Formula 21 above was used.

### COMPARATIVE EXAMPLE 5

### Preparation of Electrolyte

An electrolyte was prepared in the same manner as in Comparative Example 2, except that 2.00 mol of the compound represented by Formula 21 above was used.

### EVALUATION EXAMPLE 1

### Measurement of Ion Conductivity of Cells Using Electrolytes of Examples 1-5, Example 8, and Comparative Examples 1-5

Cells 1 through 5 for evaluation and comparative cells 1-5 were prepared to have the following stack structures.

Cell 1

Li/electrolyte of Example 1(PEO₁₈LiTFSI-0.40PP13FSI)/Li stack structure

Cell 2

Li/electrolyte of Example 2(PEO₁₈LiTFSI-0.80PP13FSI)/Li stack structure

Cell 3

Li/electrolyte of Example 3(PEO₁₈LiTFSI-1.20PP13FSI)/Li stack structure

Cell 4

Li/electrolyte of Example 4(PEO₁₈LiTFSI-1.60PP13FSI)/Li stack structure

Cell 5

Li/electrolyte of Example 5(PEO₁₈LiTFSI-2.00PP13FSI)/Li stack structure

Cell 6

Li/electrolyte of Example 8(PEO₁₈LiTFSI-2.40PP13FSI)/Li stack structure

Comparative Cell 1

Li/electrolyte of Comparative Example 1(PEO₁₈LiTFSI)/Li stack structure

Comparative Cell 2

Li/electrolyte of Comparative Example 2(PEO₁₈LiTFSI-0.48PP13TFSI)/Li stack structure

Comparative Cell 3

Li/electrolyte of Comparative Example 3(PEO₁₈LiTFSI-0.96PP13TFSI)/Li stack structure

Comparative Cell 4

Li/electrolyte of Comparative Example 4(PEO₁₈LiTFSI-1.44PP13TFSI)/Li stack structure

Comparative Cell 5

Li/electrolyte of Comparative Example 5(PEO₁₈LiTFSI-2.00PP13TFSI)/Li stack structure

In the above cells, PEO₁₈ indicates polyethylene oxide (H—[O—CH₂CH₂]₁₈—OH, polymerization degree: 18, weight-average molecular weight: about 600,000), PP13FSI indicates the compound represented by Formula 15 above, and PP13TFSI indicates a compound represented by Formula 21 above.

The conductivity was obtained by performing an inverse operation on impedance.

The impedance was evaluated such that an alternating voltage of approximately 5 mV was applied as an open circuit voltage to each cell at about 1,000,000 hertz (Hz) to about 0.1 Hz and a profile was illustrated as an impedance function having real and imaginary parts.

The evaluation results of the conductivities of the cells 1 through 6 and the comparative cell 1 are shown in FIG. 3. The measurement results of the cells 1 through 5 and the comparative cells 1 through 5 are shown in Table 1 below, wherein x indicates the amount (in moles) of the compound represented by Formula 15 above. Thus, the cells wherein x is 0.00, 0.40, 0.80, 1.20, 1.60, and 2.0 correspond to the electrolytes of Comparative Example 1 and Examples 1 through 5.

TABLE 1

| | Conductivity | | Conductivity |
|---|---|---|---|
| | (siemens per | | (siemens per |
| Division | centimeter) | Division | centimeter) |
| Cell 1(x = 0.40) | 1.45 × 10⁻⁵ | Comparative Cell 1 | 5.13 × 10⁻⁶ |
| | | (x = 0.00) | |
| Cell 2(x = 0.80) | 3.29 × 10⁻⁵ | Comparative Cell | 2.15 × 10⁻⁶ |
| | | 2(x = 0.48) | |
| Cell 3(x = 1.20) | 4.63 × 10⁻⁵ | Comparative Cell | 2.02 × 10⁻⁵ |
| | | 3(x = 0.96) | |
| Cell 4(x = 1.60) | 7.12 × 10⁻⁵ | Comparative Cell | 2.34 × 10⁻⁵ |
| | | 4(x = 1.44) | |
| Cell 5(x = 2.00) | 1.04 × 10⁻⁴ | Comparative Cell | 7.1 × 10⁻⁵ |
| | | 5(x = 2.00) | |

Referring to FIG. 3, cells 1 through 6 have increased conductivities compared to the comparative cell 1. In addition, as shown in Table 1, cells 1 through 5 have increased conductivities compared to the comparative examples 2 through 5 in which an ionic liquid has a similar range compared to the cells 1 through 5.

### EVALUATION EXAMPLE 2

### Measurement of Impedance and Conductivity of Cell Using Electrolytes of Examples 6 and 7 and Comparative Example 1

Cells 7 through 9 for evaluation and a comparative cell 1 were prepared to have the following stack structures.

Cell 7

Li/electrolyte of Example 6(PEO₁₈LiTFSI-1.44PP13FSI)/Li stack structure

Cell 8

Li/electrolyte of Example 7(PEO₁₈LiTFSI-1.44PP13FSI—BaTiO₃)/Li stack structure

Cell 9

Li/electrolyte of Example 7(PEO₁₈LiTFS1-1.44PP13FSI—BaTiO₃)/LATP/1 M LiCl(aq.)/Pt stack structure

Comparative Cell 1

Li/electrolyte of Comparative Example 1(PEO₁₈LiTFSI)/Li stack structure

In the cells 7 through 9 and the comparative cell 1, PEO₁₈ indicates polyethylene oxide (H—[O—CH₂CH₂]₁₈—OH, polymerization degree: 18, weight-average molecular weight: about 600,000 g/mol), PP13FSI indicates the compound represented by Formula 15 above, and x indicates the amount (moles) of the compound represented by Formula 15 above.

In the cell 9, LATP indicates Li_{1.4}Al_{0.42}Ti_{1.6}P₃O_{12.03} and 1 M of LiCl(aq.) indicates 1 M of an aqueous lithium chloride solution.

In the cells 7 through 9 and the comparative cell 1, impedances were measured.

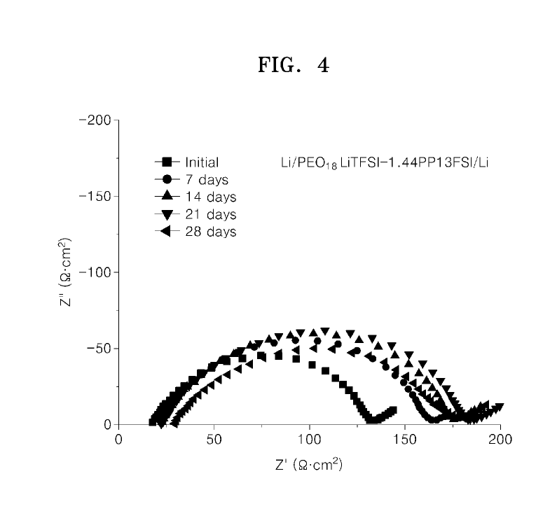

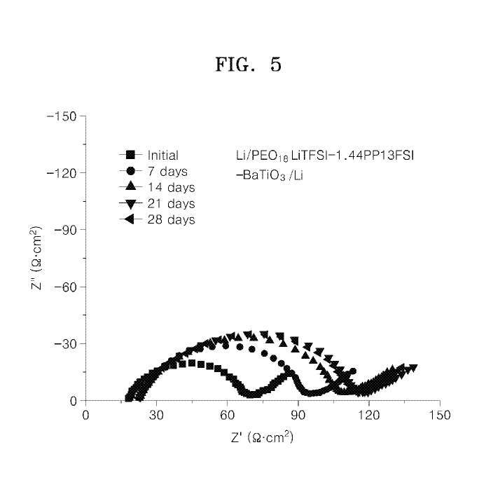

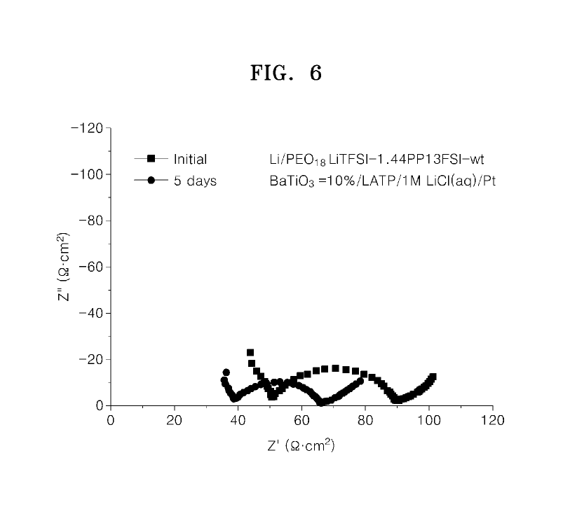

The measurement results of the impedances are shown in FIGS. 4 through 6.

The impedance was evaluated such that an alternating voltage of approximately 5 millivolts (mV) was applied as an open circuit voltage to each cell at about 1,000,000 Hz to about 0.1 Hz and a profile was illustrated as an impedance function having real and imaginary parts.

Referring to FIGS. 4 through 6, the impedance characteristics of the cells 7 through 9 using the electrolytes of Examples 6 and 7 increase according to time. In addition, the cells 7 through 9 using the electrolytes of Examples 6 through 7 have higher conductivity than that of the cell 4 using the electrolyte of Comparative Example

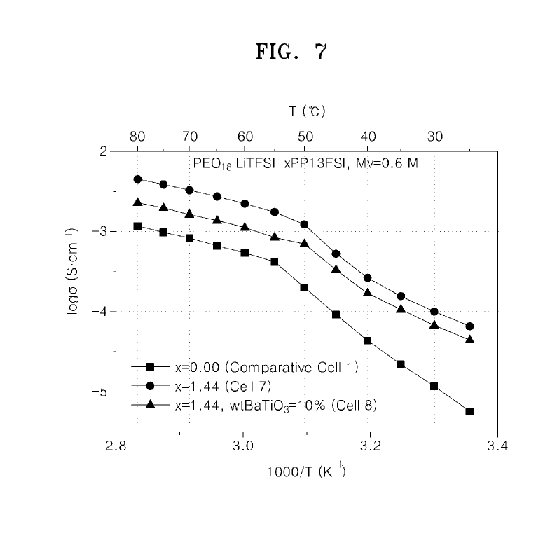

A change in conductivity of each of the cells using the electrolytes of Examples 6 and 7 and Comparative Example 1 (that is, cells 7, 8, and 9, and comparative cell 1) was evaluated, and the results are illustrated in FIG. 7 and Table 2 below.

The change in conductivity was evaluated using an impedance analyzer such that a change in conductivity was measured over a period of 35 days.

TABLE 2

Conductivity
(siemens per centimeter)

| Division | 25□ | 60□ |
|---|---|---|
| Example 6 | 6.45 × 10⁻⁵ | 2.18 × 10⁻³ |
| Example 7 | 4.39 × 10⁻⁵ | 1.10 × 10⁻³ |
| Comparative Example 1 | 5.50 × 10⁻⁶ | 5.29 × 10⁻⁴ |

Referring to FIG. 7 and Table 2 above, the cells using the electrolytes of Examples 6 and 7 (cells 6 and 7) have a higher conductivity than that of the cells the cells using the electrolytes of Comparative Example 1(Comparative cell 1) and have no change in conductivity according to time.

As described above, according to an embodiment of this disclosure, the lithium air battery including the electrolyte may have increased ion conductivity.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electrolyte comprising:
a lithium ion conductive polymer,
a lithium salt, and
an ionic liquid comprising an anion represented by Formula 1 below: 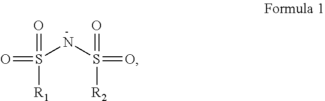
wherein, in Formula 1 above, R₁ and R₂ are the same and are fluorine, R₁ and R₂ are different and are fluorine or a perfluoroalkyl group, or R₁ and R₂ are connected to each other to form a ring, wherein all hydrogen atoms of the ring are substituted with fluorine or all hydrogen atoms of the ring are substituted with fluorine or a perfluoroalkyl group.

2. The electrolyte of claim 1, wherein the perfluoroalkyl group is —CF₃.

3. The electrolyte of claim 1, wherein the ionic liquid further comprises a cation selected from an ammonium cation, an imidazolium cation, a pyrrolidinium cation, a piperidinium cation, a phosphonium cation, and a combination thereof.

4. The electrolyte of claim 1, wherein the anion represented by Formula 1 above is an anion selected from an anion represented by Formulae 2 through 4 below, and a combination thereof:

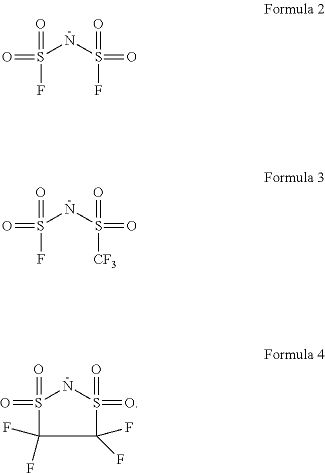 [SMILES: O=S(=O)(F)NS(=O)(=O)F ; O=S(=O)(F)NS(=O)(=O)C(F)(F)F ; O=S1(=O)NS(=O)(=O)C(F)(F)C1(F)F]

5. The electrolyte of claim 1, wherein the ionic liquid comprises a cation selected from a cation represented by Formulae 5 through 7 below, and a combination thereof: 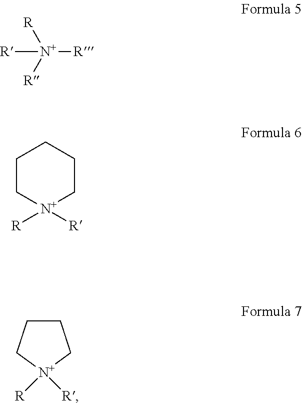
wherein, in Formulae 5 through 7, R, R′, R″, and R′″ are each independently a C₁-C₁₀ alkyl group.

6. The electrolyte of claim 1, wherein the ionic liquid is a salt selected from a salt represented by Formulae 8 through 13 below, and a combination thereof: 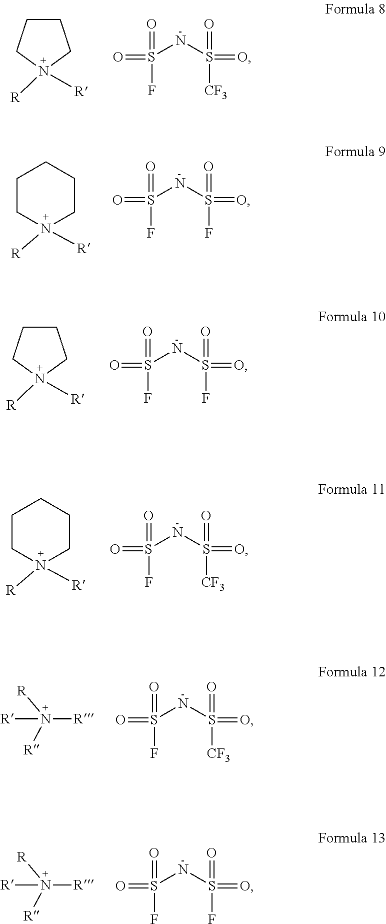
wherein, in Formulae 8-13 above, R, R′, R″, and R′″ are each independently a C₁-C₁₀ alkyl group.

7. The electrolyte of claim 1, wherein the ionic liquid is a salt selected from a salt represented by Formulae 14 through 19 below, and a combination thereof:

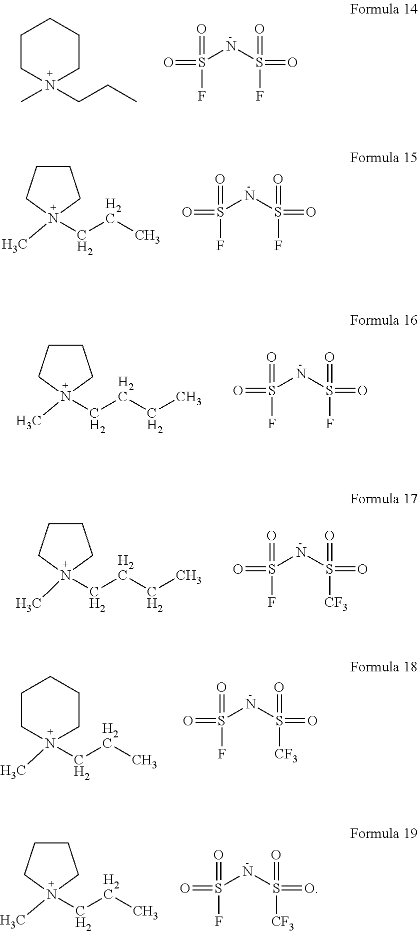

8. The electrolyte of claim 1, wherein an amount of the ionic liquid in the electrolyte is about 0.1 moles to about 2 moles, based on 1 mole of the lithium ion conductive polymer.

9. The electrolyte of claim 1, wherein the lithium salt comprises a compound selected from LiPF₆, LiBF₄, LiSbF₆, LiAsF₆, LiN(SO₂C₂F₅)₂, LiN(SO₂F₂)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) wherein x and y are integers ranging from 0 to 10, LiF, LiBr, LiCl, LiI, LiB(C₂O₄)₂, and a combination thereof.

10. The electrolyte of claim 1, wherein an amount of the lithium salt is present in the electrolyte in an amount effective to provide a ratio of moles of lithium ions/moles of oxygen atoms of the lithium ion conductive polymer of about 1/6 to about 1/54.

11. The electrolyte of claim 1, further comprising an inorganic filler.

12. The electrolyte of claim 11, wherein the inorganic filler comprises an inorganic compound selected from BaTiO₃, SiO₂, TiO₂, ZrO₂, zeolite, and a combination thereof.

13. The electrolyte of claim 11, wherein an amount of the inorganic filler in the electrolyte ranges from about 0.1 to about 20 parts by weight based on 100 parts by weight of a total weight of the lithium ion conductive polymer, the lithium salt, and the ionic liquid.

14. A lithium air battery comprising:
a positive electrode;
a first electrolyte; and
a negative electrode,
wherein the first electrolyte is disposed between the negative electrode and the positive electrode, and is the electrolyte of claim 1.

15. The lithium air battery of claim 14, wherein the perfluoroalkyl group is —CF₃.

16. The lithium air battery of claim 14, further comprising a protective layer interposed between the first electrolyte and the positive electrode.

17. The lithium air battery of claim 16, wherein the protective layer comprises a membrane selected from an inorganic solid electrolyte membrane, a polymer solid electrolyte membrane, a gel-type polymer electrolyte membrane, a lithium ion conductive solid electrolyte membrane, and a combination thereof.

18. The lithium air battery of claim 16, further comprising a second electrolyte interposed between the positive electrode and the protective layer.

19. The lithium air battery of claim 18, wherein the second electrolyte comprises a material selected from a liquid electrolyte comprising a separator, a non-aqueous solvent, and a lithium salt, an inorganic solid electrolyte membrane, a polymer solid electrolyte membrane, a lithium ion conductive solid electrolyte membrane, a gel-type polymer electrolyte membrane, and a combination thereof.

20. The lithium air battery of claim 18, wherein the second electrolyte comprises a liquid electrolyte comprising a non-aqueous solvent and a lithium salt.
